(19) United States
(12) Patent Application Publication
(10) Pub. No.: US 2026/0222651 A1
(43) Pub. Date: Jul. 30, 2026

(54) DISPLAY DEVICE

(71) Applicant: LG ELECTRONICS INC., Seoul (KR)

(72) Inventors: O Bong AN, Seoul (KR); Sang Jin AHN, Seoul (KR); Seong Woon SEOL, Seoul (KR)

(73) Assignee: LG ELECTRONICS INC., Seoul (KR)

(21) Appl. No.: 19/147,531

(22) PCT Filed: Jan. 12, 2023
(86) PCT No.: PCT/KR2023/000597

§ 371 Date: Jul. 11, 2025

(51) Int. Cl. H04N 21/4722; G06F 3/16; G10L 25/93; H04N 21/41; H04N 21/422

(52) U.S. Cl. CPC H04N 21/4722; G06F 3/16; G10L 25/93; H04N 21/41265; H04N 21/42203

(57) ABSTRACT

A display device according to an aspect may include a microphone; a controller configured to receive a microphone-on command from a remote-control device to control the microphone to be turned on; and a display configured to display music information searched based on audio recorded by the microphone from a time of receiving the microphone-on command.

### TECHNICAL FIELD

The present disclosure relates to a display device for searching music included in content.

### BACKGROUND ART

An electronic device including a display device can provide various contents. As the contents are diverse, the types of music included in the contents can also be diverse.

For example, the audio of the contents can vary depending on the genre of the contents. If the genre of the contents is a music-related genre, the audio of the contents can include only music. On the other hand, if the genre of the contents is not a music-related genre, the music can be included along with the voice that speaks the dialogue. If the genre of the contents is not a music-related genre, the music included in the contents can be background music.

In addition, the contents can include original music or cover song music in which someone other than the original singer covered the original song.

Demand for searching music in the contents is increasing. Conventional music search devices can search for music by recording audio. As an example of a music search device, there can be a display device that provides a music search function.

However, conventional display devices have a problem in that the process for searching for music is complicated, such as going through a separate step of activating a microphone to record audio. Accordingly, when starting to record audio to search for music, there is a problem that the music you want to search for is over. In addition, there is a problem that the user has to wait for the time that the audio is being recorded.

In addition, since the conventional display device performs one audio recording, there is a problem that the music recognition rate is significantly reduced when noise is included in the audio recording process.

In addition, the conventional display device has a problem that it is difficult to provide information on various music, including original songs and cover songs, using a single music search engine.

### INVENTION

### Technical Problem

The present disclosure seeks to advance the time at which a display device initiates audio recording for music search.

The present disclosure seeks to enable music search to be performed using other recorded audio when the display device fails to obtain music search results using some of the recorded audio.

The present disclosure seeks to subdivide the process by which a display device performs music search according to music included in content.

### Technical Solution

A display device according to an aspect may include a microphone; a controller configured to receive a microphone-on command from a remote-control device to control the microphone to be turned on; and a display configured to display music information searched based on audio recorded by the microphone from a time of receiving the microphone-on command.

The display device according to an embodiment of the present disclosure may display the music information searched based on the audio recorded by the microphone from a time of receiving a content recommendation command that executes a content recommendation menu.

The display device according to an embodiment of the present disclosure, based on receiving an activation word that activates the display device, may display the music information searched based on the audio recorded by the microphone from a time of receiving the activation word.

The display device according to an embodiment of the present disclosure may generate multiple audio files by starting recording multiple times from the time of receiving the microphone-on command, and display the music information searched based on at least one of the multiple audio files.

The display device according to an embodiment of the present disclosure may generate multiple audio files by starting recording at a preset interval from the time of receiving the microphone-on command, and display the music information searched based on at least one of the multiple audio files.

The display device according to an embodiment of the present disclosure may display the music information based on an audio file selected based on at least one of a silent section ratio or an SNR (Signal to Noise Ratio) level of each of the multiple audio files.

The display device according to an embodiment of the present disclosure may display the music information based on an audio file of which the silent section ratio is less than a preset reference ratio among the multiple audio files.

The display device according to an embodiment of the present disclosure may display the music information based on an audio file of which the SNR level is higher than a preset reference level among the multiple audio files.

The display device according to an embodiment of the present disclosure may obtain an order of audio files to be used for music search based on at least one of the silent section ratio or the SNR level of each of the selected audio files.

The display device according to an embodiment of the present disclosure may obtain an audio file having a smallest ratio of the silent section among the selected audio files as a first audio file used in a first priority for the music search, and obtain an audio file having a greatest ratio of the silent section after the first audio file as an audio file used in a second priority for the music search.

The display device according to an embodiment of the present disclosure may obtain an audio file having a greatest SNR level among the selected audio files as a first audio file used in a first priority for the music search, and obtain an audio file having a smallest SNR level after the first audio file as an audio file used in a second priority for the music search.

The display device according to an embodiment of the present disclosure may obtain a genre of the content being displayed on the display from an external server, and obtain whether to remove a signal other than music included in the audio based on the genre of the content.

The display device according to an embodiment of the present disclosure, based on the genre of the contents being not a music-related genre, may display the music information searched based on an audio from which a signal other than the music signal included in the audio is removed.

The display device according to an embodiment of the present disclosure may perform a music search corresponding to the audio recorded by the microphone in at least one of a plurality of music search engines including an original song search engine and a cover song search engine.

The display device according to an embodiment of the present disclosure, based on a music search result being not obtained from the original song search engine, may perform a music search in the cover song search engine.

### Effect of the Invention

A display device according to an embodiment of the present disclosure can shorten the time between the time when a music search command is received and the time when a music search result is displayed.

A display device according to an embodiment of the present disclosure can minimize the possibility of failure in obtaining a search result by performing music search using multiple audio files sequentially.

A display device according to an embodiment of the present disclosure can reduce the amount of computation required for music search depending on the music included in the content, or shorten the time until the time when a music search result is displayed.

### DESCRIPTION OF DRAWINGS

FIG. 1 is a block diagram illustrating a configuration of a display device according to an embodiment of the present disclosure.

FIG. 2 is a block diagram illustrating a remote-control device according to an embodiment of the present disclosure.

FIG. 3 is a diagram illustrating an actual configuration of a remote-control device according to an embodiment of the present disclosure.

FIG. 4 is a diagram illustrating an example of utilizing a remote-control device according to an embodiment of the present disclosure.

FIG. 5 is a block diagram for describing a mobile terminal related to the present disclosure.

FIG. 6 is a diagram for describing a time point at which the conventional display device initiates audio recording for music search.

FIG. 7 is a flowchart for describing a method for searching for music by a display device according to an embodiment of the present disclosure.

FIG. 8 is a diagram for describing a case where a display device according to an embodiment of the present disclosure receives a music search command after completing audio recording.

FIG. 9 is a diagram illustrating a case where a display device according to an embodiment of the present disclosure receives a music search command before completing audio recording.

FIG. 10 is a diagram illustrating a content recommendation menu displayed by a display device according to an embodiment of the present disclosure according to a content recommendation command.

FIG. 11 is a diagram illustrating a menu displayed by a mobile terminal connected to a display device according to an embodiment of the present disclosure to control the display device.

FIG. 12 is a diagram illustrating an example of a mobile terminal connected to a display device according to an embodiment of the present disclosure displaying a menu for controlling the display device.

FIG. 13 is a diagram illustrating a screen displayed by a display device according to an embodiment of the present disclosure upon receiving a start word.

FIG. 14 is a diagram illustrating a screen displaying a menu including a music search item according to an embodiment of the present disclosure.

FIG. 15 is a diagram illustrating a method for a display device according to an embodiment of the present disclosure to initiate multiple recordings.

FIG. 16 is a flowchart illustrating a method for searching for music information using multiple files recorded by the display device according to one embodiment of the present disclosure.

FIG. 17 is a diagram for describing a method for a display device according to an embodiment of the present disclosure to select audio files to be used for music search based on the silent section ratio of each of the multiple audio files.

FIG. 18 is a diagram for describing a method for selecting an audio file to be used for music search based on the SNR (Signal to Noise Ratio) level of each of multiple audio files by a display device according to one embodiment of the present disclosure.

### BEST MODE

Hereinafter, embodiments relating to the present invention will be described in detail with reference to the accompanying drawings. The suffixes “module” and “unit” for components used in the description below are assigned or mixed in consideration of easiness in writing the specification and do not have distinctive meanings or roles by themselves.

A display device according to an embodiment of the present invention, for example, as an artificial display device that adds a computer supporting function to a broadcast receiving function, may have an easy-to-use interface such as a writing input device, a touch screen, or a spatial remote-control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS may be used.

Accordingly, since various applications are freely added or deleted on a general purpose OS kernel, a display device described in the present invention, for example, may perform various user-friendly functions. The display device, in more detail, may be a network TV, Hybrid Broadcast Broadband TV (HBBTV), smart TV, light-emitting diode (LED) TV, organic light-emitting diode (OLED) TV, and so on and in some cases, may be applied to a smartphone.

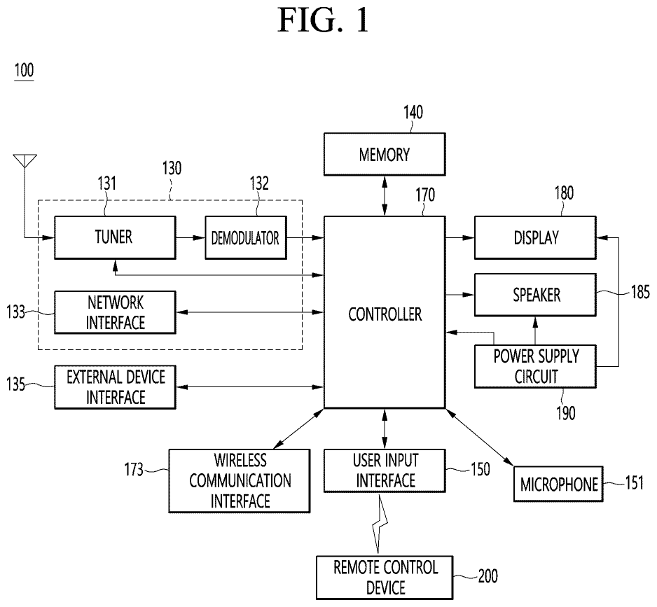

FIG. 1 is a block diagram illustrating a configuration of a display device according to an embodiment of the present disclosure.

Referring to FIG. 1, a display device 100 may include a broadcast reception module 130, an external device interface 135, a memory 140, a user input interface 150, a controller 170, a wireless communication interface 173, a display 180, a speaker 185, and a power supply circuit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulator 132 may divide the received broadcast signals into video signals, audio signals, and broadcast program-related data signals, and may restore the divided video signals, audio signals, and data signals into an output available form.

The external device interface 135 may receive an application or an application list in an adjacent external device and deliver the application or the application list to the controller 170 or the memory 140.

The external device interface 135 may provide a connection path between the display device 100 and an external device. The external device interface 135 may receive at least one of an image or audio outputted from an external device that is wirelessly or wiredly connected to the display device 100 and deliver the received image or the audio to the controller. The external device interface 135 may include a plurality of external input terminals. The plurality of external input terminals may include an RGB terminal, at least one High Definition Multimedia Interface (HDMI) terminal, and a component terminal.

An image signal of an external device inputted through the external device interface 135 may be outputted through the display 180. A sound signal of an external device inputted through the external device interface 135 may be outputted through the speaker 185.

An external device connectable to the external device interface 135 may be one of a set-top box, a Blu-ray player, a DVD player, a game console, a sound bar, a smartphone, a PC, a USB Memory, and a home theater system but this is just exemplary.

The network interface 133 may provide an interface for connecting the display device 100 to a wired/wireless network comprising internet network. The network interface 133 may transmit or receive data to or from another user or another electronic device through an accessed network or another network linked to the accessed network.

Additionally, some content data stored in the display device 100 may be transmitted to a user or an electronic device, which is selected from other users or other electronic devices pre-registered in the display device 100.

The network interface 133 may access a predetermined webpage through an accessed network or another network linked to the accessed network. That is, the network interface 133 may transmit or receive data to or from a corresponding server by accessing a predetermined webpage through the network.

The network interface 133 may receive content or data provided from a content provider or a network operator. That is, the network interface 133 may receive content, such as movies, advertisements, games, VODs, and broadcast signals, which are provided from the content provider or the network operator, and information relating thereto through the network.

In addition, the network interface 133 may receive firmware update information and update files provided from the network operator, and may transmit data to the Internet or content provider or the network operator.

The network interface 133 may select and receive a desired application among applications open to the air, through network.

The memory 140 may store signal-processed image, voice, or data signals stored by a program in order for each signal processing and control in the controller 170.

In addition, the memory 140 may perform a function for temporarily storing image, voice, or data signals output from the external device interface 135 or the network interface 133, and may store information on a predetermined image through a channel memory function.

The memory 140 may store an application or an application list input from the external device interface 135 or the network interface 133.

The display device 100 may play content files (e.g., video files, still image files, music files, document files, application files, etc.) stored in the memory 140, and may provide the content files to a user.

The user input interface 150 may transmit signals input by a user to the controller 170, or may transmit signals from the controller 170 to a user. For example, the user input interface 150 may receive or process control signals such as power on/off, channel selection, and screen setting from the remote-control device 200 or transmit control signals from the controller 170 to the remote-control device 200 according to various communication methods such as Bluetooth, Ultra Wideband (WB), ZigBee, Radio Frequency (RF), and IR communication methods.

In addition, the user input interface 150 may transmit, to the controller 170, control signals input from local keys (not shown) such as a power key, a channel key, a volume key, and a setting key.

Image signals that are image-processed by the controller 170 may be input to the display 180 and displayed as images corresponding to the image signals. In addition, image signals that are image-processed by the controller 170 may be input to an external output device through the external device interface 135.

Voice signals processed by the controller 170 may be output to the speaker 185. In addition, voice signals processed by the controller 170 may be input to the external output device through the external device interface 135.

Additionally, the controller 170 may control overall operations of the display device 100.

In addition, the controller 170 may control the display device 100 by a user command or an internal program input through the user input interface 150, and may access the network to download a desired application or application list into the display device 100.

The controller 170 may output channel information selected by a user together with the processed image or voice signals through the display 180 or the speaker 185.

In addition, the controller 170 may output image signals or voice signals of an external device such as a camera or a camcorder, which are input through the external device interface 135, through the display 180 or the speaker 185, according to an external device image playback command received through the user input interface 150.

Moreover, the controller 170 may control the display 180 to display images, and may control the display 180 to display broadcast images input through the tuner 131, external input images input through the external device interface 135, images input through the network interface, or images stored in the memory 140. In this case, an image displayed on the display 180 may be a still image or video and also may be a 2D image or a 3D image.

Additionally, the controller 170 may play content stored in the display device 100, received broadcast content, and external input content input from the outside, and the content may be in various formats such as broadcast images, external input images, audio files, still images, accessed web screens, and document files.

Moreover, the wireless communication interface 173 may perform wired or wireless communication with an external device. The wireless communication interface 173 may perform short-range communication with an external device. For this, the wireless communication interface 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication interface 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication interface 173 may detect (or recognize) a wearable device capable of communication around the display device 100.

Furthermore, in the case that the detected wearable device is a device authenticated to communicate with the display device 100, the controller 170 may transmit at least part of data processed in the display device 100 to the wearable device through the wireless communication interface 173. Therefore, a user of the wearable device may use the data processed by the display device 100 through the wearable device.

The display 180 may convert image signals, data signals, or on-screen display (OSD) signals, which are processed in the controller 170, or images signals or data signals, which are received in the external device interface 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface 133 or the external device interface 135 and play them without including the tuner 131 and the demodulator 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display 180 and the speaker 185.

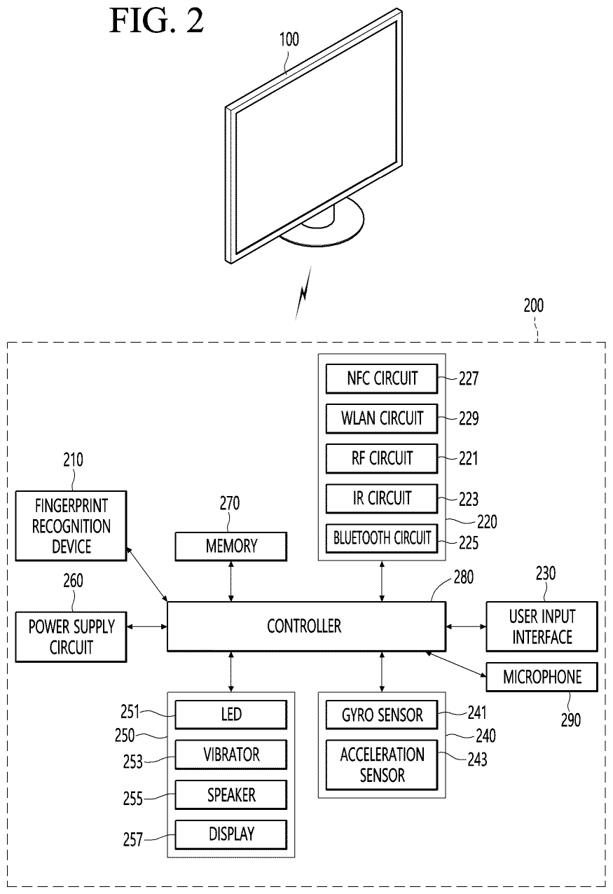

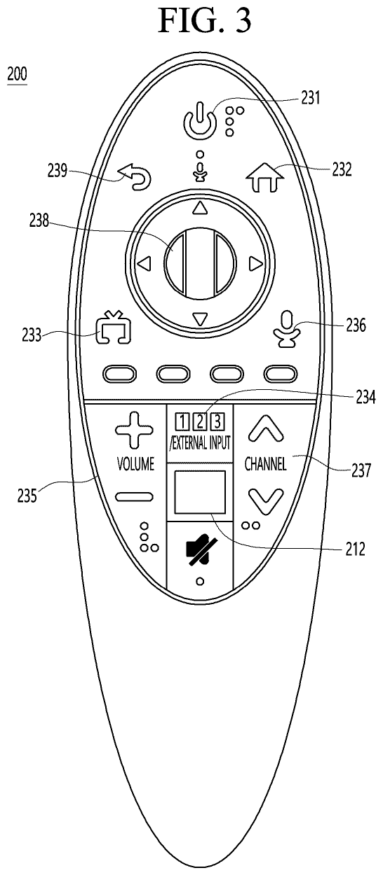

A remote-control device according to an embodiment of the present disclosure will be described with reference to FIGS. 2 and 3.

FIG. 2 is a block diagram illustrating a remote-control device according to an embodiment of the present disclosure, and FIG. 3 is a diagram illustrating an actual configuration of a remote-control device according to an embodiment of the present disclosure.

First, referring to FIG. 2, a remote-control device 200 may include a fingerprint recognition module 210, a wireless communication interface 220, a user input interface 230, a sensor 240, an output interface 250, a power supply circuit 260, a memory 270, a controller 280, and a microphone 290.

Referring to FIG. 2, the wireless communication interface 220 transmits/receives signals to/from an arbitrary any one of display devices according to the above-mentioned embodiments of the present disclosure.

The remote-control device 200 may include a radio frequency (RF) circuit 221 capable of transmitting or receiving signals to or from the display device 100 according to an RF communication standard, and an IR circuit 223 capable of transmitting or receiving signals to or from the display device 100 according to an IR communication standard. In addition, the remote-control device 200 may include a Bluetooth circuit 225 capable of transmitting or receiving signals to or from the display device 100 according to a Bluetooth communication standard. In addition, the remote-control device 200 may include an NFC circuit 227 capable of transmitting or receiving signals to or from the display device 100 according to an NFC communication standard, and a wireless LAN (WLAN) circuit 229 capable of transmitting or receiving signals to or from the display device 100 according to a WLAN communication standard.

In addition, the remote-control device 200 may transmit signals containing information on the movement of the remote-control device 200 to the display device 100 through the wireless communication interface 220.

Moreover, the remote-control device 200 may receive signals transmitted from the display device 100 through the RF circuit 221 and if necessary, may transmit a command for power on/off, channel change, and volume change to the display device 100 through the IR circuit 223.

The user input interface 230 may be configured with a keypad, a button, a touch pad, or a touch screen. A user may operate the user input interface 230 to input a command relating to the display device 100 to the remote-control device 200. In the case that the user input interface 230 includes a hard key button, a user may input a command relating to the display device 100 to the remote-control device 200 through the push operation of the hard key button. This will be described with reference to FIG. 3.

Referring to FIG. 3, the remote-control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display device 100.

The home button 232 may be a button for moving to the home screen of the display device 100.

The live button 233 may be a button for displaying live broadcast programs.

The external input button 234 may be a button for receiving an external input connected to the display device 100.

The volume control button 235 may be a button for controlling a volume output from the display device 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input interface 230 includes a touch screen, a user may touch a soft key of the touch screen to input a command relating to the display device 100 to the remote-control device 200. In addition, the user input interface 230 may include various kinds of input interfaces operable by a user, for example, a scroll key and a jog key, and this embodiment does not limit the scope of the present disclosure.

The sensor 240 may include a gyro sensor 241 or an acceleration sensor 243. The gyro sensor 241 may sense information on the movement of the remote-control device 200.

For example, the gyro sensor 241 may sense information on an operation of the remote-control device 200 on the basis of x, y, and z axes and the acceleration sensor 243 may sense information on a movement speed of the remote-control device 200. Moreover, the remote-control device 200 may further include a distance measurement sensor that senses a distance with respect to the display 180 of the display device 100.

The output interface 250 may output image or voice signals in response to the operation of the user input interface 230, or may output image or voice signals corresponding to signals transmitted from the display device 100.

A user may recognize whether the user input interface 230 is operated or the display device 100 is controlled through the output interface 250.

For example, the output interface 250 may include an LED module 251 for flashing, a vibration module 253 for generating vibration, a speaker 255 for outputting sound, or a display module 257 for outputting an image, if the user input interface 230 is manipulated or signals are transmitted/received to/from the display device 100 through the wireless communication interface 220.

Additionally, the power supply circuit 260 supplies power to the remote-control device 200 and if the remote-control device 200 does not move for a predetermined time, stops the power supply, so that power waste may be reduced.

The power supply circuit 260 may resume the supply of power if a predetermined key provided at the remote-control device 200 is operated.

The memory 270 may store various kinds of programs and application data required to control or operate the remote-control device 200.

If the remote-control device 200 transmits/receives signals wirelessly through the display device 100 and the RF circuit 221, the remote-control device 200 and the display device 100 transmits/receives signals through a predetermined frequency band.

The controller 280 of the remote-control device 200 may store, in the memory 270, information on a frequency band for transmitting/receiving signals to/from the display device 100 paired with the remote-control device 200 and refer to it.

The controller 280 controls general matters relating to the control of the remote-control device 200. The controller 280 may transmit a signal corresponding to a predetermined key operation of the user input interface 230 or a signal corresponding to the movement of the remote-control device 200 sensed by the sensor 240 to the display device 100 through the wireless communication interface 220.

In addition, the microphone 290 of the remote-control device 200 may acquire voice.

A plurality of the microphone 290 may be provided.

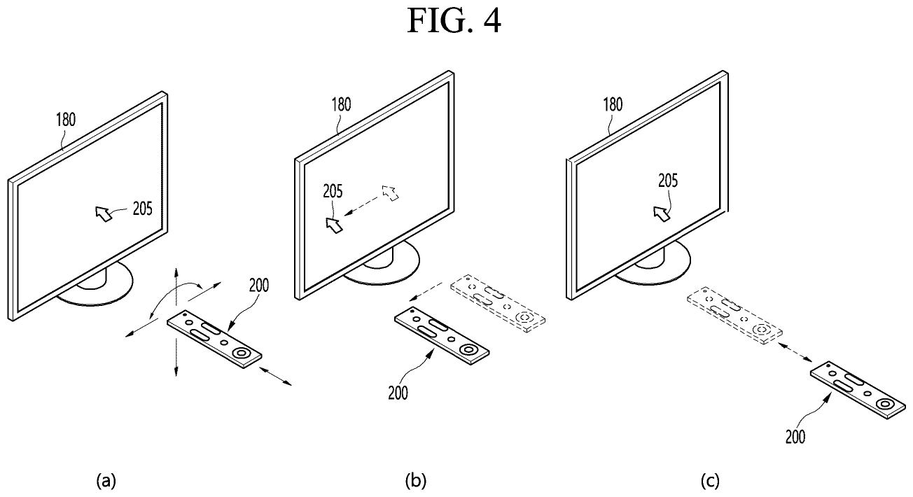

Next, FIG. 4 is described.

FIG. 4 is a diagram illustrating an example of utilizing a remote-control device according to an embodiment of the present disclosure.

FIG. 4(a) illustrates that a pointer 205 corresponding to the remote-control device 200 is displayed on the display 180.

A user may move or rotate the remote-control device 200 vertically or horizontally. The pointer 205 displayed on the display 180 of the display device 100 corresponds to a movement of the remote-control device 200. Since the corresponding pointer 205 is moved and displayed according to a movement on a 3D space as show in the drawing, the remote-control device 200 may be referred to as a spatial remote-control device.

FIG. 4(b) illustrates that if a user moves the remote-control device 200, the pointer 205 displayed on the display 180 of the display device 100 is moved to the left according to the movement of the remote-control device 200.

Information on a movement of the remote-control device 200 detected through a sensor of the remote-control device 200 is transmitted to the display device 100. The display device 100 may calculate the coordinates of the pointer 205 from the information on the movement of the remote-control device 200. The display device 100 may display the pointer 205 to match the calculated coordinates.

FIG. 4(c) illustrates that while a specific button in the remote-control device 200 is pressed, a user moves the remote-control device 200 away from the display 180. Thus, a selected region in the display 180 corresponding to the pointer 205 may be zoomed in and displayed in an enlarged size.

On the other hand, if a user moves the remote-control device 200 close to the display 180, a selection area in the display 180 corresponding to the pointer 205 may be zoomed out and displayed in a reduced size.

Meanwhile, if the remote-control device 200 is moved away from the display 180, a selection area may be zoomed out and if the remote-control device 200 is moved closer to the display 180, a selection area may be zoomed in.

Additionally, if a specific button in the remote-control device 200 is pressed, recognition of a vertical or horizontal movement may be excluded. That is, if the remote-control device 200 is moved away from or closer to the display 180, the up, down, left, or right movement cannot be recognized and only the back and forth movement may be recognized. While a specific button in the remote-control device 200 is not pressed, only the pointer 205 is moved according to the up, down, left or right movement of the remote-control device 200.

Moreover, the moving speed or moving direction of the pointer 205 may correspond to the moving speed or moving direction of the remote-control device 200.

Furthermore, a pointer in this specification means an object displayed on the display 180 in response to an operation of the remote-control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display 180 and also may be displayed in correspondence to a plurality of points such as a line and a surface.

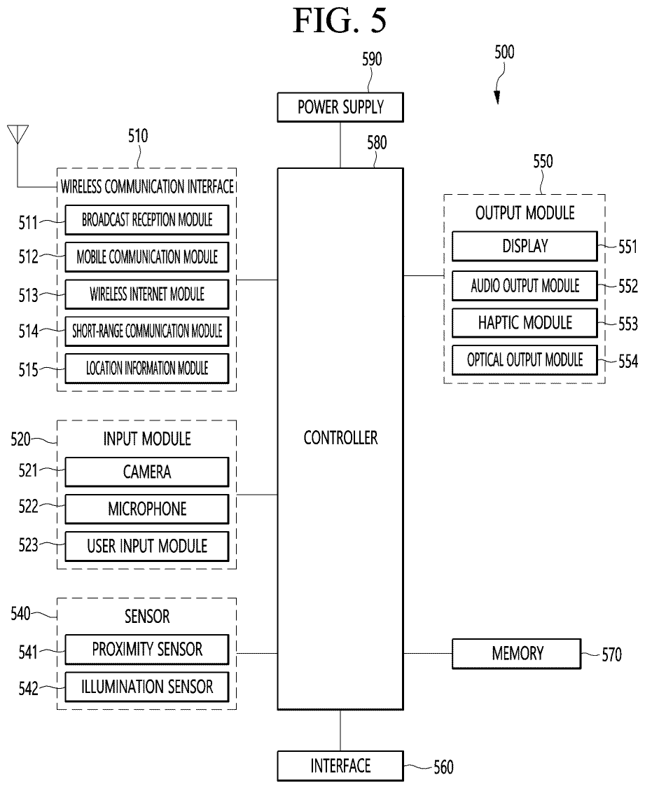

Next, referring to FIG. 5, a configuration of a mobile terminal related to the present disclosure will be described.

FIG. 5 is a block diagram for describing a mobile terminal related to the present disclosure.

A mobile terminal 500 may include a wireless communication interface 510, an input module 520, a sensor 540, an output module 550, an interface 560, a memory 570, a controller 580, and a power supply 590. The components illustrated in FIG. 5 are not essential for implementing the mobile terminal, and thus the mobile terminal described in this specification may have more or fewer components than the components listed above.

More specifically, among the components, the wireless communication interface 510 may include one or more modules that enable wireless communication between the mobile terminal 500 and the wireless communication system, between the mobile terminal 500 and another mobile terminal 500, or between the mobile terminal 500 and an external server. In addition, the wireless communication interface 510 may include one or more modules that connect the mobile terminal 500 to one or more networks.

The wireless communication interface 510 may include at least one of a broadcast reception module 511, a mobile communication module 512, a wireless Internet module 513, a short-range communication module 514, or a location information module 515.

The input module 520 may include a camera 521 or an image input module for inputting an image signal, a microphone 522 or an audio input module for inputting an audio signal, and a user input module 523, for example, a touch key, a mechanical key, etc. for receiving information from a user. Voice data or image data collected by the input module 520 may be analyzed and processed as a user control command.

The sensor 540 may include one or more sensors for sensing at least one of information within the mobile terminal, information about the surrounding environment surrounding the mobile terminal, and user information. For example, the sensor 540 may include at least one of a proximity sensor 541, an illumination sensor 542, a touch sensor, an acceleration sensor, a magnetic sensor, a G-sensor, a gyroscope sensor, a motion sensor, an RGB sensor, an infrared sensor IR sensor, a fingerprint recognition sensor, an ultrasonic sensor, an optical sensor, a microphone, a battery gauge, an environmental sensor (e.g., a barometer, a hygrometer, a thermometer, a radiation detection sensor, a heat detection sensor, a gas detection sensor, etc.), or a chemical sensor (e.g., an electronic nose, a healthcare sensor, a biometric recognition sensor, etc.). Meanwhile, the mobile terminal disclosed in the present specification may utilize information sensed by at least two or more of these sensors in combination.

The output module 550 is for generating output related to visual, auditory or tactile sensations, and may include at least one of a display 551, an audio output module 552, a haptic module 553, or an optical output module 554. The display 551 may be formed as a touch sensor and a mutual layer structure or formed as an integral body, thereby implementing a touch screen. This touch screen may function as a user input module 523 that provides an input interface between the mobile terminal 500 and the user, and may provide an output interface between the mobile terminal 500 and the user.

The interface 560 serves as a passageway for various types of external devices connected to the mobile terminal 500. The interface 560 may include at least one of a wired/wireless headset port, an external charger port, a wired/wireless data port, a memory card port, a port for connecting a device equipped with an identification module, an audio I/O Input/Output port, a video I/O Input/Output port, or an earphone port. In the mobile terminal 500, appropriate control related to the connected external device may be performed in response to the external device being connected to the interface 560.

In addition, the memory 570 stores data supporting various functions of the mobile terminal 500. The memory 570 may store a plurality of application programs (or applications) running on the mobile terminal 500, data for the operation of the mobile terminal 500, and commands. At least some of these application programs may be downloaded from an external server via wireless communication. In addition, at least some of these applications may exist on the mobile terminal 500 from the time of shipment for the basic functions of the mobile terminal 500 (e.g., incoming and outgoing calls, receiving and outgoing messages). Meanwhile, the application programs may be stored in the memory 570, installed on the mobile terminal 500, and driven by the controller 580 to perform the operations (or functions) of the mobile terminal.

In addition to the operations related to the application programs, the controller 580 typically controls the overall operations of the mobile terminal 500. The controller 580 may process signals, data, information, etc. input or output through the components discussed above, or may drive the application programs stored in the memory 570 to provide or process appropriate information or functions to the user.

In addition, the controller 580 may control at least some of the components discussed with FIG. 5 in order to drive the application programs stored in the memory 570. In addition, the controller 580 may operate at least two or more of the components included in the mobile terminal 500 in combination to drive the application program.

The power supply 590 receives external power and internal power under the control of the controller 580 and supplies power to each component included in the mobile terminal 500. The power supply 590 includes a battery, and the battery may be a built-in battery or a replaceable battery.

At least some of the components may operate in cooperation with each other to implement the operation, control, or control method of the mobile terminal according to various embodiments described below. In addition, the operation, control, or control method of the mobile terminal may be implemented on the mobile terminal by driving at least one application program stored in the memory 570.

In this specification, the display device 100 may be a music search device that provides a music search function. However, the music search device may be not only the display device 100 but also the mobile terminal 500 described in FIG. 5. That is, the music search device is a device that displays the results of searching for music according to the method described below, and its form may be various, such as the display device 100 or the mobile terminal 500.

Hereinafter, for the convenience of description, it is assumed that the music search device is the display device 100.

As an example of a method for the display device 100 to search for music, there is a method of searching for music information using audio recorded by the microphone 151. That is, the display device 100 may search for music having a signal similar to the signal of the audio recorded with the microphone 151. Accordingly, the display device 100 may provide information on music having an audio signal similar to the audio recorded with the microphone 151.

Meanwhile, the conventional display device 100 goes through one or more steps to record audio with the microphone 151 to search for music.

For example, the conventional display device 100 starts audio recording by receiving a voice command for music search after going through a step of turning on the microphone 151.

Alternatively, the conventional display device 100 starts audio recording by receiving a user input for selecting a music search function included in the application after going through a step of running an application installed on the display device 100.

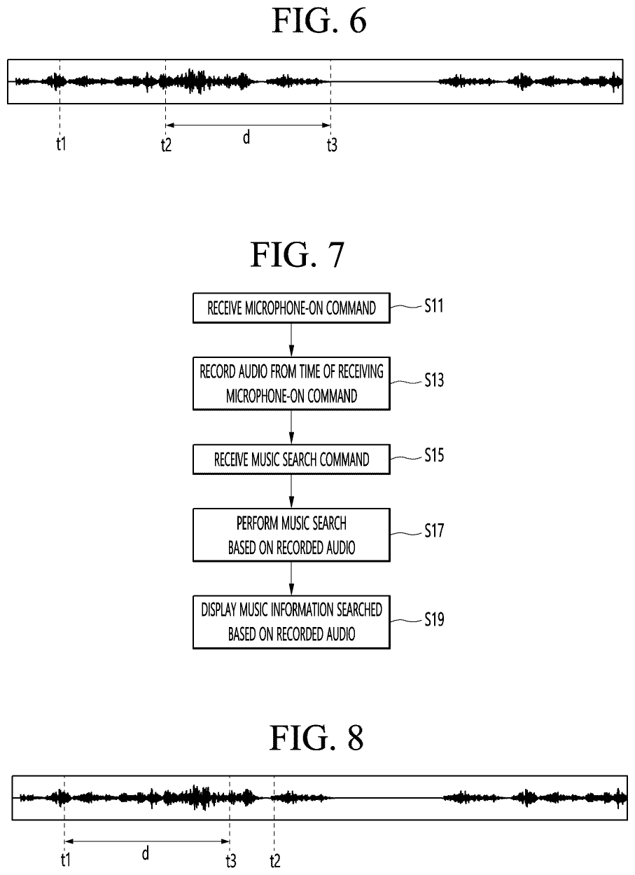

Referring to FIG. 6, a description will be given of the time point at which the conventional display device 100 initiates audio recording for music search.

FIG. 6 is a diagram for describing a time point at which the conventional display device initiates audio recording for music search.

FIG. 6 may be a diagram illustrating a waveform of audio recordable through the microphone 151.

The controller 170 may record audio from a time point t2 at which a music search command is received. The time point t2 at which the music search command is received may be the time point t2 at which the controller 170 initiates audio recording. The music search command may be a command for searching for music.

The controller 170 may enter a state in which the music search command may be received before receiving the music search command.

For example, the controller 170 may receive the music search command through the microphone 151. To this end, the controller 170 may receive a microphone-on command to enter a state in which the music search command may be received.

A time point t1 at which the controller 170 enters a state in which the music search command may be received may be the time point t1 at which the user intends to search for music.

However, between the time point t1 at which the user intends to search for music and the time point t2 at which audio recording is initiated, the music included in the content may be interrupted or changed to other music.

Accordingly, the audio including the music that the user intended to search for may not be recorded at the time point t2 at which the controller 170 initiates audio recording. Accordingly, there is a problem in which the user may not search for the music that he intended to search for.

Meanwhile, the controller 170 may record audio for a preset time d from the time t2 when the music search command is received. The preset time d may be set as the minimum recording time for obtaining a music search result using the recorded audio, but is not limited thereto.

A time t3 when the audio recording is completed may be the preset time d after the time t2 when the music search command is received.

When the audio recording is completed, the controller 170 may display music information searched for based on the recorded audio.

Accordingly, the time when the controller 170 displays the searched music information may be after the time t3 when audio recording is completed.

Therefore, when the controller 170 records the audio from the time point t2 when the music search command is received, the time between the time point t1 when the user intends to search for music and the time point when the searched music information is displayed may be longer than the preset time d.

Accordingly, the conventional display device 100 has a problem in that it takes more than the preset time d from the time point t2 when the music search command is received to the time point when the searched music information is provided.

Accordingly, the display device 100 according to one embodiment of the present disclosure intends to start recording audio for music search at a time point earlier than the time point t2 when the music search command is received.

Next, a method for searching for music by the display device 100 according to an embodiment of the present disclosure will be described.

FIG. 7 is a flowchart for describing a method for searching for music by a display device according to an embodiment of the present disclosure.

The controller 170 may receive a microphone-on command for controlling the microphone 151 to turn on (step S11).

For example, the controller 170 may receive the microphone-on command for controlling the microphone 151 to turn on from the remote-control device 200.

The microphone-on command may be a command for turning on the microphone 151 to receive a user's voice command. The voice command may include the music search command.

The controller 170 may receive the music search command through the microphone 151 controlled to turn on.

The music search command may be a command to search for music of the content. For example, the music search command may be a command to search for music of the content being displayed through the display 180.

Meanwhile, the step in which the controller 170 receives the microphone-on command may be a step in which the music search command may be received.

The state in which the music search command may be received may vary depending on the embodiment. For example, the state in which the music search command may be received may include not only the state in which the microphone 151 is turned on to receive the music search command, but also the state in which a menu supporting the music search command has been entered.

The controller 170 may record audio from the time of receiving the microphone-on command (step S13).

The controller 170 may record audio from the time of receiving the microphone-on command. The controller 170 may start audio recording at the time of receiving the microphone-on command.

That is, the controller 170 may record audio before receiving the music search command.

The controller 170 may record audio for a preset time from the time of starting audio recording.

The preset time may be set as the minimum recording time for obtaining music search results using the recorded audio, but is not limited thereto. For example, the preset time may be 6 seconds, but is not limited thereto.

According to an embodiment, the controller 170 may start audio recording in various cases where it enters a state in which a music search command may be received.

The controller 170 may receive the music search command (step S15).

The controller 170 may receive the music search command through the microphone 151.

The controller 170 may perform music search based on the recorded audio (step S17).

The controller 170 may perform a music search when it receives the music search command. For example, the controller 170 may perform a music search corresponding to the audio in a music search engine when receiving the music search command.

The music search engine may be a search engine that obtains and provides music information most similar to the audio from a music database.

For example, the music search engine may analyze the frequency of an audio file and then obtain and provide music information having a frequency most similar to the frequency of the audio file from a music database.

The music search engine may include an original song search engine and a cover song search engine.

The original song search engine may be a search engine for obtaining sound source information most similar to an audio file from an original song database. The original song database may be a database in which audio files including the voice and instrument sounds of an original singer included in the music are stored.

The cover song search engine may be a search engine for obtaining cover song information most similar to an audio file from a cover song database. The cover song database may be a database in which audio files including the voice and instrument sounds of a person other than the original singer included in the music are stored.

The controller 170 may perform a music search corresponding to audio recorded by the microphone 151 in at least one of a plurality of music search engines including the original song search engine and the cover song search engine.

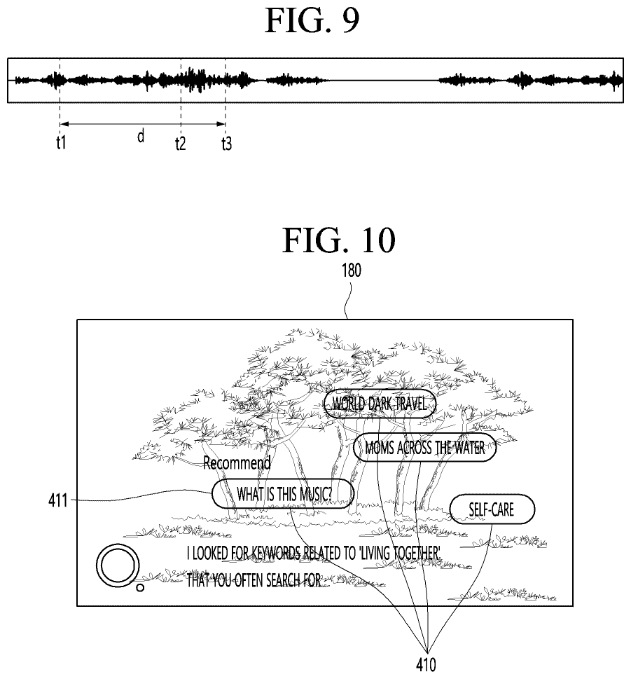

Steps S13 to S17 of the controller 170 will be specifically described with reference to FIGS. 8 to 9 regarding the time at which audio is recorded and music search is performed based on the recorded audio.

FIG. 8 is a diagram for describing a case where a display device according to an embodiment of the present disclosure receives a music search command after completing audio recording.

FIG. 8 may be a diagram illustrating a waveform of audio recordable through the microphone 151.

The controller 170 may initiate audio recording at the time t1 at which the music search command is entered into a state in which the music search command may be received. The time t1 at which the music search command is entered into a state in which the music search command may be received may be the time t1 at which the user intends to search for music.

The controller 170 may record audio for a preset time d from the time t1 at which the user intends to search for music. The preset time d may be 6 seconds, but is not limited thereto.

The time point t3 at which the controller 170 completes audio recording may be before the time point t2 at which the music search command is received.

Accordingly, the controller 170 may perform music search immediately based on the recorded audio upon receiving the music search command.

FIG. 9 is a diagram illustrating a case where a display device according to an embodiment of the present disclosure receives a music search command before completing audio recording.

FIG. 9 may be a diagram illustrating a waveform of audio that may be recorded by the microphone 151.

The controller 170 may receive the music search command while recording audio. The time point t3 at which the controller 170 completes audio recording may be after the time point t2 at which the music search command is received.

The controller 170 may perform music search based on the recorded audio at the time t3 when audio recording is completed.

Since the controller 170 starts audio recording at the time t1 when the user intends to search for music, the time between the time t2 when the music search command is received and the time t3 when audio recording is completed may be shorter than the preset time d.

The display device 100 according to the embodiments of FIGS. 8 and 9 may start audio recording at the time t1 when the user intends to search for music.

Again, FIG. 7 will be described.

The controller 170 may display music information searched based on the recorded audio (step S19).

The controller 170 may display the music information searched based on the recorded audio.

The searched music information may include a title, a singer, an album name, an album cover, a release date, and the like of the searched music.

In addition, the controller 170 may display the accuracy of the searched music together. The accuracy of the searched music may be the degree of consistency between the searched music and the recorded audio.

Summarizing FIG. 7, the display device 100 according to one embodiment of the present disclosure may start audio recording for music search from the time when the user intends to search for music before receiving the music search command.

Accordingly, the display device 100 according to one embodiment of the present disclosure may minimize the problem that the music is stopped before the audio recording is started and the user may not record the music intended to be searched for.

In addition, the display device 100 according to one embodiment of the present disclosure has the advantage of shortening the time until the music search result is displayed.

The case where the start of audio recording is brought forward to the point where the user wants to search for music is not limited to the case described above.

That is, the display device 100 according to one embodiment of the present disclosure may immediately start audio recording if it is determined that it is capable of receiving the music search command in addition to the microphone-on command. Hereinafter, various embodiments will be described in detail.

In relation to this, it will be described with reference to FIGS. 10 to 14.

FIG. 10 is a diagram illustrating a content recommendation menu displayed by a display device according to an embodiment of the present disclosure according to a content recommendation command.

The controller 170 may execute a content recommendation menu 410 according to a content recommendation command that executes the content recommendation menu.

The content recommendation command may be an input of pressing a voice recognition button 236 of the remote-control device 200 for less than a preset time, but is not limited thereto.

The content recommendation menu 410 may include a menu for recommending other content related to a specific content. The content recommendation menu 410 may include a music search item 411 for searching for music of a specific content. According to an embodiment, the music search item 411 may be displayed as an item including the text ‘What is this music?’.

The user input for selecting the music search item 411 may be a music search command. That is, the controller 170 may enter a state in which the music search command may be received by executing the content recommendation menu.

The controller 170 may start audio recording using the microphone 151 at the time of receiving the content recommendation command. The time at which the controller 170 starts audio recording may be before receiving the music search command.

Next, the controller 170 may perform music search when receiving the user input for selecting the music search item 411.

Accordingly, the controller 170 may display the music information searched based on the recorded audio from the time of receiving the content recommendation command.

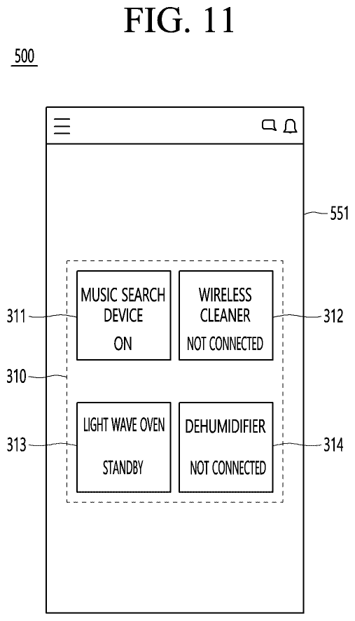

FIG. 11 is a diagram illustrating a menu displayed by a mobile terminal connected to a display device according to an embodiment of the present disclosure to control the display device.

FIG. 11 may be a diagram illustrating a main menu 310 of an application displayed on the display 551 of the mobile terminal 500.

The application displayed on the display 551 of the mobile terminal 500 may be an application for controlling various electronic devices registered to the mobile terminal 500.

The main menu 310 of the application may include a list of electronic devices registered to the mobile terminal 500. The electronic devices registered to the mobile terminal 500 may be electronic devices that have been wirelessly connected to the mobile terminal 500 or are currently wirelessly connected to the mobile terminal 500 and may be controlled using the mobile terminal 500.

The electronic device registered in the mobile terminal 500 may include the display device 100. Accordingly, the display device 100 may be included in the list of electronic devices registered in the mobile terminal 500.

Meanwhile, in addition to the display device 100, various electronic devices such as a wireless cleaner, a light wave oven, and a dehumidifier may be registered in the mobile terminal 500.

The list of electronic devices registered in the mobile terminal 500 may include items corresponding to various electronic devices such as an item 311 corresponding to the display device, an item 312 corresponding to a wireless cleaner, an item 313 corresponding to a light wave oven, and an item 314 corresponding to a dehumidifier.

In addition, each item corresponding to the electronic device may include operation information of the electronic device such as ‘on’, ‘not connected’, and ‘standby’.

When the mobile terminal 500 receives an input for selecting the item 311 corresponding to the display device among the items included in the main menu 310, the mobile terminal may display the menu for controlling the display device 100.

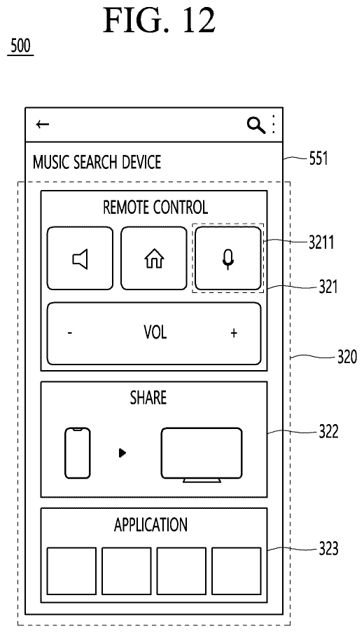

The menu for controlling the display device 100 will be specifically described with reference to FIG. 12.

FIG. 12 is a diagram illustrating an example of a mobile terminal connected to a display device according to an embodiment of the present disclosure displaying a menu for controlling the display device.

A menu 320 for controlling the display device 100 may include a remote-control item 321, a sharing item 322, an application item 323, and the like.

The remote-control item 321 may be an item for remotely controlling the display device 100. The remote-control item 321 may include an icon 3211 for turning on the microphone 522 of the mobile terminal.

The mobile terminal 500 may control the microphone 522 to turn on when receiving a user input for selecting the icon 3211 for turning on the microphone.

The mobile terminal 500 may receive a voice command for remotely controlling the display device 100 through the microphone 522. The voice command may include the music search command.

That is, the mobile terminal 500 may enter a state in which the music search command may be received by receiving a user input for selecting the icon 3211 for turning on the microphone 522 of the mobile terminal.

Meanwhile, when the mobile terminal 500 receives a user input for selecting the icon 3211 to turn on the microphone 522 of the mobile terminal, it may transmit a signal to the display device 100 to notify this.

The display device 100 may initiate audio recording based on a signal received from the mobile terminal 500.

That is, the display device 100 may initiate audio recording when the mobile terminal 500 enters a state in which a music search command may be received. Accordingly, the time point at which the display device 100 initiates audio recording may be before the mobile terminal 500 receives a voice command.

When the mobile terminal 500 receives the voice command, it may transmit information including the voice command to the display device 100.

The display device 100 may obtain that the voice command is the music search command based on the information received from the mobile terminal 500. The display device 100 may perform music search based on the obtained music search command.

Accordingly, the display device 100 may display the music information searched based on recorded audio from the time of receiving a user input selecting the icon 3211 for turning on the microphone 522.

Meanwhile, the display device 100 may start recording audio when the remote-control device 200 enters a state where it may receive the music search command.

For example, the remote-control device 200 may receive a command to turn on the microphone 290. The command to turn on the microphone 290 may be an input of pressing and releasing the voice recognition button 236 for a preset time or longer, but is not limited thereto.

The remote-control device 200 may receive the voice command for the display device 100 through the microphone 290. The voice command may include the music search command.

That is, the remote-control device 200 may enter a state in which it may receive the music search command for the display device 100.

Meanwhile, when the remote-control device 200 receives a command to turn on the microphone 290, it may transmit a signal to the display device 100 to notify this.

The display device 100 may initiate audio recording based on the signal received from the remote-control device 200.

That is, when the remote-control device 200 enters a state in which it may receive the music search command, it may record audio. Accordingly, the point in time when the display device 100 initiates audio recording may be before the remote-control device 200 receives the voice command.

When the remote-control device 200 receives the voice command, it may transmit information including the voice command to the display device 100.

The display device 100 may obtain that the voice command is the music search command based on the information received from the remote-control device 200. The display device 100 may perform music search based on the obtained music search command.

Accordingly, the display device 100 may display the searched music information based on the recorded audio from the time point when the mobile terminal 500 receives a user input selecting the icon 3211 for turning on the microphone 522.

Accordingly, the display device 100 may display the searched music information based on the recorded audio from the time point when the remote-control device 200 receives a user input selecting the icon 3211 for turning on the microphone 522.

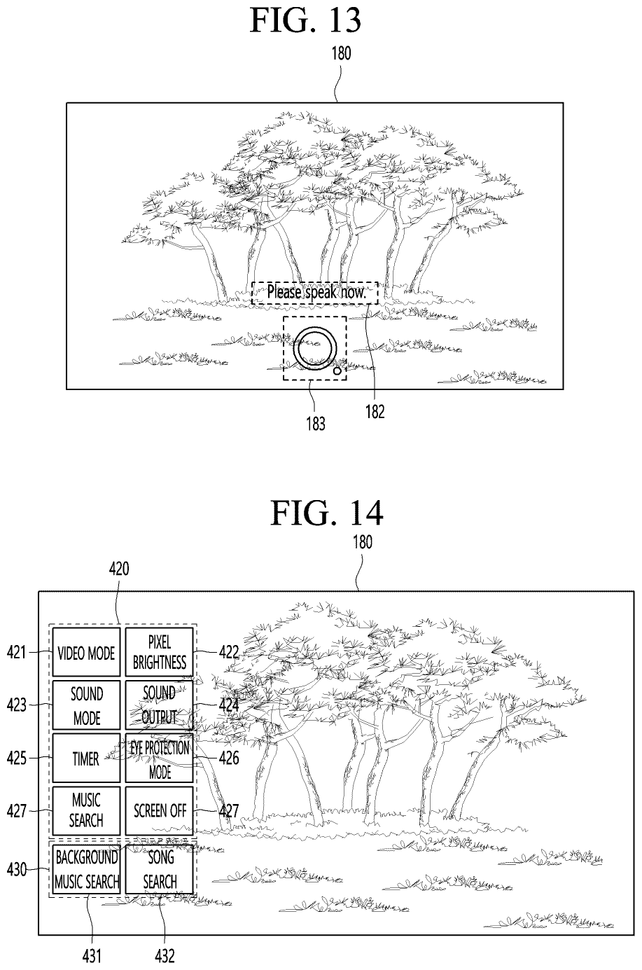

FIG. 13 is a diagram illustrating a screen displayed by a display device according to an embodiment of the present disclosure upon receiving a start word.

The controller 170 may receive a trigger word to start the display device 100 through the microphone 151. The trigger word may be a command to start the display device 100 to obtain a user's voice command. The trigger word may be a sentence or word including the manufacturer name of the display device 100, but the trigger word may be various.

When the controller 170 receives the trigger word, it may activate the microphone 151 to obtain the user's voice command.

When the controller 170 receives the trigger word, it may display at least a part of a message 182 to notify that it is waiting for the user's voice command or an icon 183 to indicate that it is waiting to obtain the voice command.

The message 182 to notify that it is waiting to obtain the voice command may be, but is not limited to, “Please speak now.”

The icon 183 for indicating that it is waiting to acquire the voice command may be a stationary icon, but may also be a moving icon, such as a rotating icon. In the case that the icon 183 for indicating that it is waiting to acquire the voice command is a moving icon, the user may know that it is waiting to acquire the voice command while the icon 183 is moving.

The controller 170 may operate based on the input voice command after receiving the activation word. Accordingly, the controller 170 may operate according to the voice command only when the user clearly intends to enter the display device 100 with the voice command.

The voice command may include the music search command. That is, the controller 170 may enter a state in which it is possible to receive the music search command by receiving the activation word.

The controller 170 may start audio recording using the microphone 151 at the time of receiving the activation word. The controller 170 may initiate audio recording before receiving the music search command.

Next, the controller 170 may perform music search upon receiving the music search command.

Accordingly, the controller 170 may display the music information searched based on the recorded audio from the time the sound activation word is received.

FIG. 14 is a diagram illustrating a screen displaying a menu including a music search item according to an embodiment of the present disclosure.

The menu including the music search item may include a quick setting menu 420. The quick setting menu 420 may be a menu for easily changing the setting state of the display device 100 during content playback.

The controller 170 may display the quick setting menu 420 based on a user input. The user may easily access the items included in the quick setting menu 420 during content playback. For example, the user input for displaying the quick setting menu 420 may be an input of pressing a setting button not shown of a remote-control button 200, but is not limited thereto.

The quick setting menu 420 may include various items for the convenience of the user. For example, the quick setting menu 420 may include a video mode item 421, a pixel brightness item 422, a sound mode item 423, a sound output item 424, a timer item 425, an eye protection mode item 426, a music search item 427, a screen off item 428, and the like.

The music search item 427 may be an item for searching for music of content displayed on the display 180.

The controller 170 may display a music search menu 430 based on a user input for selecting the music search item 427.

The music search menu 430 may include a background music search item 431 and a song search item 432.

The background music search item 431 may be an item for searching for music included in the content. The user input for selecting the background music search item 431 may be the music search command for searching for music included in the content.

That is, the controller 170 may enter a state in which the music search command may be received based on the user input for selecting the music search item 427.

The controller 170 may initiate audio recording when receiving the user input for selecting the music search item 427. The time point at which the controller 170 initiates audio recording may be before receiving the music search command.

Next, the controller 170 may perform a music search when receiving the user input for selecting the background music search item 431.

Accordingly, the controller 170 may display the music information searched based on the recorded audio from the time point at which the user input for selecting the background music search item 431 is received.

The conventional display device started audio recording at the time of receiving the music search command.

On the other hand, the display device 100 according to the embodiment of FIGS. 10 to 14 may start audio recording before the time of receiving the music search command.

Therefore, the time of starting audio recording by the display device 100 according to the embodiment of FIGS. 10 to 14 may be earlier than the time of starting audio recording by the conventional display device.

Accordingly, the display device 100 according to the embodiment of FIGS. 10 to 14 may minimize the problem of a user not being able to record the music that the user intended to search for because the music at the time of intended music search is changed before starting audio recording.

In addition, the time taken by the display device 100 according to the embodiment of FIGS. 10 to 14 to display the searched music information may be shorter than the time taken by the existing display device to display the searched music information. Therefore, the display device 100 according to the embodiment of the present disclosure has the advantage of minimizing the time taken to display the searched music information.

Meanwhile, the conventional display device performed the music search using one recorded audio. Accordingly, there is a problem that the music information is not searched depending on the quality of the recorded audio.

Accordingly, the display device 100 according to one embodiment of the present disclosure records the audio multiple times to generate an audio file, and searches for music information based on at least one of the multiple audio files.

That is, the display device 100 according to one embodiment of the present disclosure may generate multiple audio files when performing step S13 of FIG. 7.

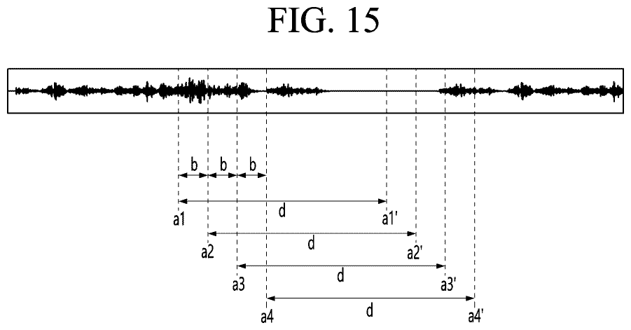

A method for generating multiple audio files by a display device 100 according to an embodiment of the present disclosure will be described with reference to FIG. 15.

FIG. 15 is a diagram illustrating a method for a display device according to an embodiment of the present disclosure to initiate multiple recordings.

The controller 170 may initiate recording at a preset interval b from a time a1 at which a user intends to record, thereby generating multiple audio files. The preset interval b may be 1 second, but is not limited thereto.

The audio file generated by the controller 170 may be a PCM (Pulse Code Modulation) file. The PCM file may be a file generated by converting an analog voice signal into a digital pulse signal. However, the audio file of the present disclosure is not limited to a PCM file.

Referring to FIG. 15, the controller 170 may record audio for a preset time d from a time point a1 at which the user intends to record in order to generate a first audio file.

The time point a1 at which the user intends to record may be a time point a1 at which the music search command may be received.

The preset time d may be 6 seconds, but is not limited thereto.

The controller 170 may record audio for the preset time d from 1 second a2 after the time point at which the user intends to record in order to generate a second audio file.

The controller 170 may record audio for the preset time d from 2 seconds a3 after the time point at which the user intends to record in order to generate a third audio file.

The controller 170 may record audio for the preset time d starting from 3 seconds a2 after the time at which the user intends to record in order to generate a fourth audio file.

Meanwhile, the number of audio files generated by the controller 170 is not limited to 4, and various numbers of audio files may be generated depending on the embodiment.

The first audio file and the second audio file may commonly include a waveform between the time at which audio recording for generating the second audio file is started a2 and the time at which audio recording for generating the first audio file is ended a1′.

The second audio file and the third audio file may commonly include a waveform between the time at which audio recording for generating the third audio file is started a3 and the time at which audio recording for generating the second audio file is ended a2′.

The third audio file and the fourth audio file may include a common waveform between the time point a4 when audio recording for generating the fourth audio file is started and the time point a3′ when audio recording for generating the third audio file is ended.

In this way, the controller 170 may generate multiple audio files that have a part in common.

That is, the display device 100 according to one embodiment of the present disclosure may generate the multiple audio files that include various sections of the same music.

Next, when the display device 100 generates the multiple audio files, a method for the controller 170 to search for music will be described.

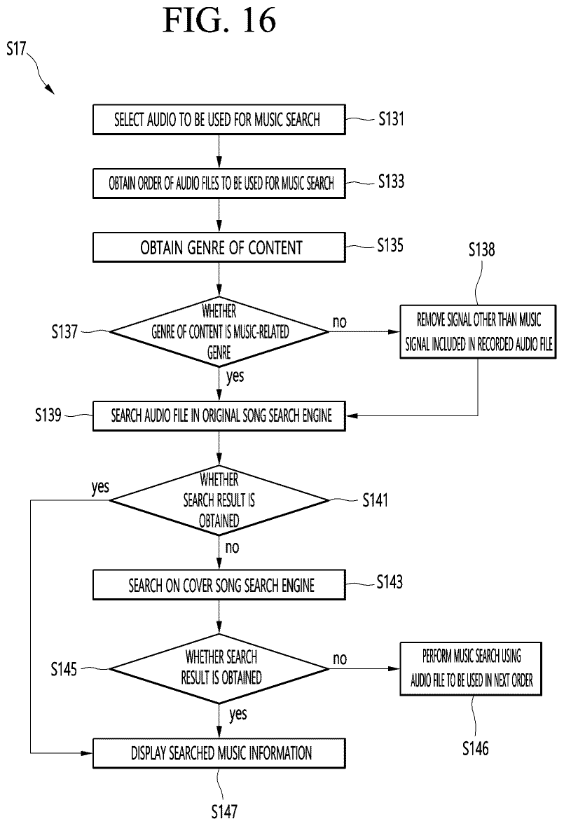

FIG. 16 is a flowchart illustrating a method for searching for music information using multiple files recorded by the display device according to one embodiment of the present disclosure.

FIG. 16 is a flowchart that specifies step S19 in the case where audio recording is initiated at multiple points in time in FIG. 7 and multiple audio files are generated.

The controller 170 may select audio to be used for music search among the multiple audio files (step S131).

The controller 170 may select audio files to be used for music search based on at least one of a silent section ratio or an SNR (Signal to Noise Ratio) level of each of the multiple audio files.

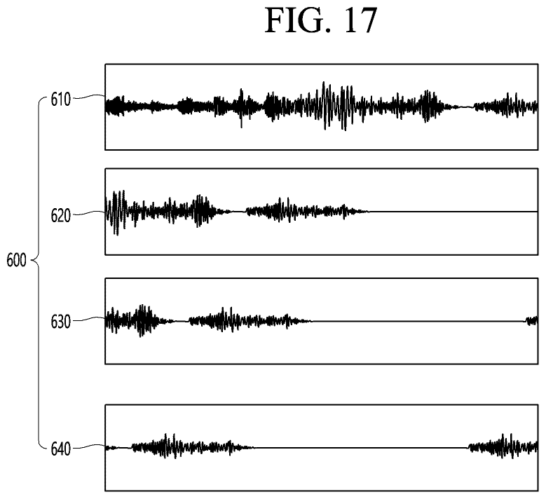

First, referring to FIG. 17, a method for the controller 170 to select audio files to be used for music search based on the silent section ratio of each of the multiple audio files will be described.

FIG. 17 is a diagram for describing a method for a display device according to an embodiment of the present disclosure to select audio files to be used for music search based on the silent section ratio of each of the multiple audio files.

FIG. 17 is a diagram illustrating audio waveforms of a first audio file 610, a second audio file 620, a third audio file 630, and a fourth audio file 640 among multiple audio files 600 generated by the controller 170.

The controller 170 may select an audio file among the multiple audio files 600 of which silent section ratio is less than a preset reference ratio.

The silent section may be a section of recorded audio in which there is no recorded sound. The silent section may be a section in which no waveform is output from the audio file.

The audio file of which the silent section ratio is greater than a preset reference ratio may be an audio file on which it is difficult to perform music search.

Referring to FIG. 17, the silent section ratio of the first audio file 610 may be 10%. The ratio of the silent section of the second audio file 620 may be 30%. The ratio of the silent section of the third audio file 630 may be 55%. The ratio of the silent section of the fourth audio file 640 may be 60%.

The preset reference ratio may be 50%. Accordingly, the controller 170 may select the first audio file 610 and the second audio file 620 of which the silent section ratio is less than or equal to the preset reference ratio of 50% as audio files to be used for music search.

The preset reference ratio is not limited to 50% and may vary depending on the embodiment.

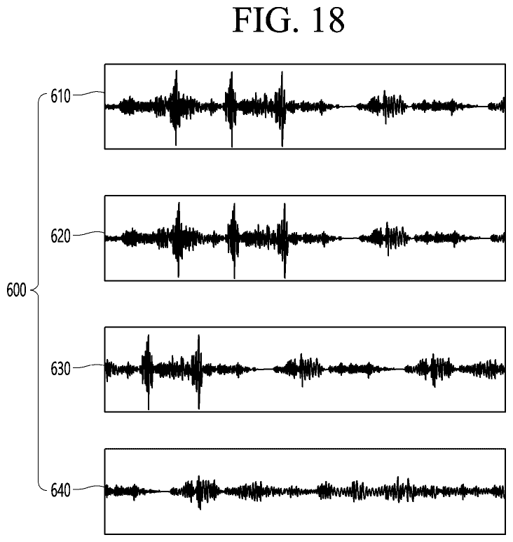

Next, referring to FIG. 18, a method for selecting an audio file to be used for music search based on the SNR (Signal to Noise Ratio) level of each of multiple audio files by the controller 170 is described.

FIG. 18 is a diagram for describing a method for selecting an audio file to be used for music search based on the SNR (Signal to Noise Ratio) level of each of multiple audio files by a display device according to one embodiment of the present disclosure.

FIG. 18 is a diagram illustrating audio waveforms of the first audio file 610, the second audio file 620, the third audio file 630, and the fourth audio file 640 among the multiple audio files 600 generated by the controller 170.

The controller 170 may display the music information based on the audio file among the multiple audio files 600 of which the SNR level is higher than a preset reference level.

The SNR level may be a ratio of the signal in which the content included in the audio file is recorded to the signal in which external noise is recorded. The lower the ratio of the signal in which external noise is recorded, the higher the SNR level may be.

The controller 170 may select an audio file among the multiple audio files 600 of which the SNR level is higher than a preset reference level.

The preset reference level may be set as a minimum level for obtaining a music search result, but is not limited thereto.

Meanwhile, the higher the ratio of the signal in which external noise is recorded, the more unstable the waveform of the audio file may appear.

Referring to FIG. 18, the first audio file 610 has three sections in which the amplitude increases rapidly and then decreases. The second audio file 620 has three sections in which the amplitude increases rapidly and then decreases. In addition, the third audio file 630 has two sections in which the amplitude increases and then decreases sharply. On the other hand, the fourth audio file 640 does not have sections in which the amplitude changes sharply.

The fourth audio file 640 has a more stable waveform than the first audio file 610, the second audio file 62, and the third audio file 630.

Accordingly, it may be seen that the fourth audio file 640 has a smaller ratio of the signal in which external noise is recorded than the first audio file 610, the second audio file 62, and the third audio file 630.

The audio file selected by the controller 170 to be used for music search may be the fourth audio file 640.

Again, FIG. 16 is described.

The controller 170 may obtain the order of audio files to be used for music search based on at least one of the ratio of silent sections or the SNR level of each of the selected audio files (step S133).

For example, the controller 170 may obtain an audio file with the smallest ratio of silent sections among the selected audio files as an audio file to be used first in music search, and may obtain an audio file with the second greatest ratio of silent sections after the first audio file as an audio file to be used second in music search.

Alternatively, the controller 170 may obtain the audio file with the highest SNR level among the selected audio files as an audio file to be used first in music search, and may obtain an audio file with the second smallest SNR level after the first audio file as an audio file to be used second in music search.

In addition, the controller 170 may obtain the order of audio files to be used for music search based on the ratio of silent sections and the SNR level.

For example, the controller 170 may obtain an audio file with a higher SNR level among audio files with a ratio of silent sections less than 30% as an audio file to be used first for music search. Accordingly, an audio file with a ratio of silent sections greater than 30% may not be used first for music search even in the case that it is an audio file with the highest SNR level.

That is, the controller 170 may set the ratio of silent sections to obtain the order to be used for search, and obtain an audio file with the highest SNR level among audio files with a ratio of silent sections lower than the set ratio as an audio file to be used first for music search.

On the contrary, the controller 170 may obtain an audio file with a lower ratio of silent sections among audio files having an SNR level higher than a predetermined level as an audio file to be used first for music search.

That is, the controller 170 sets an SNR level for obtaining an order to be used for search, and may obtain an audio file with the lowest ratio of silent sections among audio files having an SNR level higher than the set SNR level as an audio file to be used first for music search.

The controller 170 may increase the possibility of obtaining a music search result by obtaining the order of audio files to be used for music search by considering both the ratio of silent sections and the SNR level.

In addition, there may be various methods for the controller 170 to obtain an order of audio files to be used for music search based on at least one of the ratio of silent sections or the SNR level of each selected audio file.

The controller 170 may obtain the genre of the content (step S135).

The controller 170 may obtain the genre of the content from the display device 100 from an external server (not shown).

The controller 170 may obtain the genre of the content from the external server (not shown) based on automatic content analysis, EPG mapping, and the like.

The controller 170 may receive the result of automatic content analysis from the external server (not shown). The result of automatic content analysis may include a title, a genre, viewing information, and a viewing time of the content. For example, the controller 170 may transmit the video signal or audio signal of the content to the external server (not shown). Accordingly, the controller 170 may receive the result of automatic content analysis according to audio signal analysis from the external server (not shown).

The controller 170 may receive an EPG (Electronic Program Guide) mapping result from the external server (not shown). The EPG (Electronic Program Guide) mapping result may include the title, the genre, the viewing time, and the like of the content. For example, the controller 170 may transmit the playback information of the content to the external server (not shown). The playback information of the content may include the channel and playback time of the content being played on the display device 100. Accordingly, the controller 170 may receive an EPG mapping result corresponding to the playback information of the content from the external server (not shown).

In addition, the controller 170 may receive the genre of the content by transmitting recorded audio to the external server (not shown).

In addition, the external server (not shown) may include a machine learning-based server (not shown).

The controller 170 may obtain whether the genre of the content is a music-related genre from the display device 100 (step S137).

The controller 170 may obtain whether the genre of the content obtained from the external server (not shown) is a music-related genre.

The music-related genre may include concert, classical, jazz, pop, and the like.

The non-music-related genre may include movies, dramas, entertainment, documentaries, and the like.

In the case that the genre of the content is not a music-related genre, the controller 170 may remove a signal other than a music signal included in the recorded audio file (step S138).

In the case that the genre of the content is not the music-related genre, the content may include the music signal and a non-music signal.

For example, the signal other than the music signal may be a voice signal of a dialogue included in the content. The controller 170 may remove the signal other than the music signal included in the recorded audio file to increase the accuracy of the music search result.

To this end, the display device 100 may store an algorithm for extracting the music signal.

The algorithm for extracting the background music may be an algorithm that analyzes the signal of the audio file to extract the music signal and the signal other than the music signal.

In the case that the genre of the content is not a music-related genre, the controller 170 may search the audio file with the signal other than the music signal removed in the original song search engine. Alternatively, in the case that the genre of the content is the music-related genre, the controller 170 may search the audio file in the original song search engine (step S139).

In the case that the genre of the content is the music-related genre, the controller 170 may not include a signal other than the music signal in the audio file. Therefore, the step of removing signals other than the music signal included in the audio file may be omitted.

Accordingly, the amount of computation of the display device 100 may be reduced. In addition, the time required for music search may be shortened.

The controller 170 may obtain whether a music search result is obtained from the original song search engine (step S141).

In the case that the music search result is obtained from the original song search engine, the controller 170 may display the searched music information (step S147).

The music information searched from the original song search engine may include a singer, a title, an album, an album cover, an album release date, and the like of the original song. In addition, in the case that the controller 170 displays the searched music information, it may display the accuracy of the searched music together.

In the case that the search result may be obtained from the original song search engine, the step of performing search using another music search engine such as the cover song search engine may be omitted. Accordingly, the amount of computation of the display device 100 may be reduced. In addition, the time required to display music information may be shortened.

In the case that the controller 170 fails to obtain music search results from the original song search engine, it may perform search on the cover song search engine (step S143).

In the case that the controller 170 may not obtain the search result from the original song search engine, it may attempt to search for music on the cover song search engine.

In the case that the controller 170 obtains the music search result from the cover song search engine, it may display the searched music information (step S147).

The music information searched on the cover song search engine may include a singer, a title, an album, an album cover, an album release date, and the like of the cover song. In addition, in the case that the controller 170 displays the searched music information, it may display the accuracy of the searched music together.

The controller 170 may provide information on the cover song as music is searched on the cover song search engine. Accordingly, the controller 170 may provide more diverse music information than when performing music search using only the original song search engine.

In the case that the controller 170 fails to obtain the search result from the cover song search engine, it may perform music search using the audio file to be used in the next order (step S146).

In the case that the controller 170 fails to obtain a search result from the cover song search engine, it may repeat steps S135 to S147 using the audio file to be used in the next order. The controller 170 may repeat steps S139 to S148 until it obtains the music search result.

However, depending on the embodiment, steps 135 to 137 using the audio file to be used in the next order may be omitted.

For example, in the case that the controller 170 does not obtain the search result from the cover song search engine, in the case that the content is a music-related genre, the controller 170 may perform search on the original song search engine using the audio file to be used in the next order.

Alternatively, in the case that the content is not a music-related genre, the controller 170 may perform search on the original song search engine by removing signals other than the music signal included in the audio file to be used in the next order.

All audio files may be files generated from audio recorded at a time close to the time at which the user intended to record.

Accordingly, all audio files may be files generated from audio recorded while the same content is being played on the display device 100. Accordingly, it may not be necessary to repeatedly obtain the genre of the content in steps 135 to 137.

Summarizing FIG. 16, the display device 100 according to an embodiment of the present disclosure may sequentially use multiple audio files and a search engine to display the searched music information.

The display device 100 according to an embodiment of the present disclosure may generate multiple audio files and perform music search using at least one of the generated audio files. Accordingly, the problem of failure to obtain search results may be minimized compared to when music search is performed by generating one audio file.

In addition, the display device 100 according to an embodiment of the present disclosure may reduce the amount of computation for music search or shorten the time required to display music search results depending on the music included in the content.

According to an embodiment of the present disclosure, the above-described method may be implemented as a code that may be read by a processor on a medium in which a program is recorded. Examples of media that may be read by the processor include ROM, RAM, CD-ROM, magnetic tape, floppy disk, optical data storage, and the like.

The display device described above is not limited to the configuration and method of the embodiments described above, and the embodiments may be configured by selectively combining all or some of the embodiments so that various modifications may be made.

1. A display device, comprising:
a microphone;
a controller configured to receive a microphone-on command from a remote-control device to control the microphone to be turned on; and
a display configured to display music information searched based on audio recorded by the microphone from a time of receiving the microphone-on command.

2. The display device of claim 1, wherein the controller is configured to:
display the music information searched based on the audio recorded by the microphone from a time of receiving a content recommendation command that executes a content recommendation menu.

3. The display device of claim 1, wherein the controller is configured to:
based on receiving an activation word that activates the display device,
display the music information searched based on the audio recorded by the microphone from a time of receiving the activation word.

4. The display device of claim 1, wherein the controller is configured to:
generate multiple audio files by starting recording multiple times from the time of receiving the microphone-on command, and
display the music information searched based on at least one of the multiple audio files.

5. The display device of claim 1, wherein the controller is configured to:
generate multiple audio files by starting recording at a preset interval from the time of receiving the microphone-on command, and
display the music information searched based on at least one of the multiple audio files.

6. The display device of claim 5, wherein the controller is configured to:
display the music information based on an audio file selected based on at least one of a silent section ratio or an SNR (Signal to Noise Ratio) level of each of the multiple audio files.

7. The display device of claim 6, wherein the controller is configured to:
display the music information based on an audio file of which the silent section ratio is less than a preset reference ratio among the multiple audio files.

8. The display device of claim 6, wherein the controller is configured to:
display the music information based on an audio file of which the SNR level is higher than a preset reference level among the multiple audio files.

9. The display device of claim 6, wherein the controller is configured to:
obtain an order of audio files to be used for music search based on at least one of the silent section ratio and the SNR level of each of the selected audio files.

10. The display device of claim 9, wherein the controller is configured to:
obtain an audio file having a smallest ratio of the silent section among the selected audio files as a first audio file used in a first priority for the music search, and obtain an audio file having a greatest ratio of the silent section after the first audio file as an audio file used in a second priority for the music search.

11. The display device of claim 9, wherein the controller is configured to:
obtain an audio file having a greatest SNR level among the selected audio files as a first audio file used in a first priority for the music search, and obtain an audio file having a smallest SNR level after the first audio file as an audio file used in a second priority for the music search.

12. The display device of claim 1, wherein the controller is configured to:
obtain a genre of the content being displayed on the display from an external server, and obtain whether to remove a signal other than music included in the audio based on the genre of the content.

13. The display device of claim 11, wherein the controller is configured to:
based on the genre of the contents being not a music-related genre,
display the music information searched based on an audio from which a signal other than the music signal included in the audio is removed.

14. The display device of claim 6, wherein the controller is configured to:
perform a music search corresponding to the audio recorded by the microphone in at least one of a plurality of music search engines including an original song search engine and a cover song search engine.

15. The display device of claim 14, wherein the controller is configured to:
based on a music search result being not obtained from the original song search engine,
perform a music search in the cover song search engine.
